(19) United States
(12) Patent Application Publication
(10) Pub. No.: US 2005/0160836 A1
(43) Pub. Date: Jul. 28, 2005

(54) Pedal force detection device

(75) Inventors: Hideyuki Hayakawa, Nishio-city (JP); Kenji Morikawa, Hekinan-city (JP); Tetsuo Imamura, Toyoake-city (JP)

Correspondence Address: POSZ LAW GROUP, PLC, 12040 SOUTH LAKES DRIVE, SUITE 101, RESTON, VA, 20191, US

(73) Assignees: DENSO CORPORATION; TOYOTA JIDOSHA KABUSHIKI KAISHA

(21) Appl. No.: 11/038,193

(22) Filed: Jan. 21, 2005

(30) Foreign Application Priority Data
Jan. 28, 2004 (JP) 2004-19814
Nov. 19, 2004 (JP) 2004-336559

(51) Int. Cl. G01L 1/00

(52) U.S. Cl. 73/862.381

(57) ABSTRACT

In a pedal force detection device, a pedal arm unit is provided with a first arm at which a pedal is mounted, a second arm apart from the pedal and a connection portion for connecting the first and second arms. A load sensor having a matrix made of a ceramics is fixed between the first and second arms. When the pedal is depressed by a pedal force, the first arm approaches the second arm due to a resilient deformation so that the load sensor is compressed by a load. Thus, the pedal force can be determined based on the load detected by the load sensor.

### CROSS REFERENCE TO RELATED APPLICATION

This application is based on Japanese Patent Applications No. 2004-19814 filed on Jan. 28, 2004 and No. 2004-336559 filed on Nov. 19, 2004, the disclosure of which are incorporated herein by reference.

### FIELD OF THE INVENTION

The present invention relates to a pedal force detection device for detecting a force exerted on a pedal in a vehicle.

### BACKGROUND OF THE INVENTION

Generally, an electronic throttle control device is used in a vehicle for controlling an opening degree of a throttle valve and an injection amount of fuel and the like, based on an electrical signal corresponding to a depression amount of an accelerator pedal. The pedal is mounted at a pedal arm rotatably supported by a rotation support, to which a rotation sensor is attached for detecting a rotation displacement of the rotation support. Thus, the depression amount of the pedal can be determined based on the detected rotation displacement.

In this case, it is preferable that a force exerted on the pedal is detected to determine whether or not the driver depresses the pedal intentionally. For example, when the force is larger than a predetermined value, it is determined that the driver depresses the pedal intentionally. Thus, the opening degree of the throttle valve is adjusted to accelerate the vehicle. On the other hand, when the force is smaller than or equal to the predetermined value, it is determined that the driver depresses the pedal unintentionally. In this case, the opening degree of the throttle valve should not be changed, so that the vehicle is not accelerated. That is, a dead zone of the pedal can be set when it is determined that the driver depresses the pedal unintentionally, and thus improving safety of the vehicle.

In this electronic throttle control device, a pedal force detection device is needed for detecting the force (pedal force) exerted on the pedal. For example, in JP-11-139270A, a load detection unit made of a supermagnetostrictive material is used. However, in this case, a sliding friction between a push rod and a wall of the housing of the load detection unit will generate a hysteresis between the output of the load detection unit and the pedal force, so that the detection accuracy is decreased.

With reference to a pedal force detection device described in JP-3116134, a pedal arm made of a metal is provided with a hole, in which a load detection unit is buried. An isolation unit made of a resin is filled between the load detection unit and the inner wall of the hole. In this case, when the pedal is intermittently depressed to exert an intermittent load on the isolation unit, a creep of the resin will occur to form a gap between the load detection unit and the isolation unit, so that the pedal force cannot be sufficiently transmitted to the load detection unit. Therefore, the pedal force cannot be determined accurately and stably.

Moreover, it is preferable that the load detection unit (sensor) can be reduced to correspond to various attachment positions and decrease the manufacture cost. However, in general, the pedal force detection device is arranged so that the pedal force generates a larger load exerted on the load detection unit, to improve the detection accuracy thereof. As a result, a large pressing force will be applied on the small-sized load detection unit, and thus shortening the lifetime thereof.

### SUMMARY OF THE INVENTION

In view of the above problems, it is an object of the present invention to provide a pedal force detection device having a small-sized load detection unit for stably detecting a force exerted on a pedal with a satisfied accuracy.

According to the present invention, in a pedal force detection device, a load sensor (load detection unit) is provided with a matrix made of a ceramics having a large pressure-withstanding strength, so that a small-sized load sensor can be used while satisfactory detection accuracy can be maintained.

Preferably, the pedal force detection device is provided with a pedal arm unit including a first arm at which a pedal is mounted, a second arm disposed apart from the pedal and a connecting portion for connecting the first arm with the second arm. The load sensor is inserted between the first arm and the second arm. When the pedal is depressed by a pedal force, the first arm approaches the second arm due to a resilient deformation, so that a load is exerted on the load sensor which detects the load to determine the pedal force.

In this case, the pedal arm unit consists of the first and second arms, between which the load sensor is caught. Accordingly, the pedal force can be transmitted to the load sensor without an influence of a sliding friction.

Preferably, each of the connecting portion and the first and second arms has larger stiffness in other directions different from that of the resilient deformation thereof due to the pedal force, respectively. Therefore, a resilient deformation as well as a breakage of the pedal arm unit in the other directions can be restricted, thus improving the detection accuracy of the pedal force.

More preferably, in the pedal force detection device, the pedal arm unit is provided with the first arm at which the pedal is mounted, and the second arm disposed apart from the pedal. The second arm has an end connected to the first arm which has a parallel portion opposite to the second arm, so that the load sensor is inserted between the second arm and the parallel portion. Moreover, a rotational support unit is provided for supporting both the first arm and the second arm.

Therefore, the rotation of the pedal arm unit will not be influenced even if the second arm has a breakage not to be connected to the first arm. In this case, a depression amount of the pedal is detected as a significant parameter.

Preferably, the first arm has an end portion which is apart from the pedal and adjacent to the parallel portion. The end portion is bent to the side of the second arm 4. The second arm 4 is connected to the end portion near a position between the end portion and the parallel portion. Between the second arm and the parallel portion of the first arm, the load sensor is inserted. Thus, when the force is exerted on the pedal, the first arm has a larger deformation to exert a larger load on the load sensor. Therefore, the detection accuracy of the pedal force can be improved.

Preferably, the pedal force detection device further includes at least a base member having a convex portion and disposed between the load sensor and at least one of the first and second arms. The base member is capable of transmitting the load. At least the one of the first and second arms has a concave portion to contact the convex portion of the base member, so that a surface contact is provided therebetween. Accordingly, stress concentration in the base member and the first and second arms due to a point contact can be restricted, thus diminishing a breakage thereof.

Preferably, the depth of the concave portion is set so that an initial load is exerted on the load sensor. Therefore, the load sensor can be attached to the pedal arm unit without other fastening members. Moreover, the load sensor can be restricted from leaving the attachment position even if the pedal is raised.

More preferably, the pedal arm unit is made of a resin, and a load detection unit includes a load sensor and a hold member made of a metal in which the load sensor is inserted. The hold member is sandwiched in the pedal arm unit, which is integrally formed with the pedal to have a resilient deformation when the pedal force is exerted on the pedal. In the pedal arm unit, an internal stress due to the resilient deformation exerts a load on the load sensor, which detects the load to determine the pedal force.

Because the load sensor is inserted in the metal hold member to not directly contact the resin pedal arm unit, the influence of a creep of the resin on the detection of the pedal force can be restricted.

### BRIEF DESCRIPTION OF THE DRAWINGS

Other objects, features and advantages of the present invention will become more apparent from the following detailed description made with reference to the accompanying drawings, in which:

FIG. 1 is a schematic view showing a pedal assembly in which a pedal force detection device is mounted according to a first embodiment of the present invention;

FIG. 2 is a partial enlarged view of the pedal force detection device of FIG. 1;

FIG. 3 is a schematic view showing the pedal assembly in which a load adjusting unit is attached to the pedal force detection device according to the first embodiment;

FIG. 4 is a partial enlarged view of the pedal force detection device of FIG. 3;

FIG. 5 is a schematic explanatory view showing the pedal force detection device according to the first embodiment;

FIG. 6 is a schematic explanatory view showing a pedal force detection device according to a first modification of the first embodiment;

FIG. 7 is a schematic explanatory view showing a pedal force detection device according to a second modification of the first embodiment;

FIG. 8 is a schematic explanatory view showing a pedal force detection device according to a third modification of the first embodiment;

FIG. 9 is a schematic explanatory view showing a pedal force detection device according to a fourth modification of the first embodiment;

FIG. 10 is a schematic explanatory view showing a pedal force detection device according to a fifth modification of the first embodiment;

FIG. 11 is a schematic sectional view showing a pedal assembly according to a second embodiment of the present invention;

FIG. 12 is a front view of a U-shape member for holding a load sensor according to the second embodiment;

FIG. 13 is a side view of the U-shape member in which the load sensor is held according to the second embodiment;

FIG. 14 is a schematic sectional view showing the pedal assembly in which a pedal force detection device is sandwiched according to the second embodiment;

FIG. 15 is a partial enlarged view showing the pedal force detection device of FIG. 14 which is viewed in the XV direction;

FIG. 16 is a schematic view showing a pedal assembly in which a pedal force detection device is mounted according to a third embodiment of the present invention;

FIG. 17 is a schematic view showing an internal structure of the pedal force detection device according to the third embodiment;

FIG. 18 is a partial enlarged view showing the pedal force detection device of FIG. 17;

FIG. 19 is a schematic explanatory view showing the pedal force detection device of FIGS. 17 and 18;

FIG. 20 is a schematic explanatory view showing a pedal force detection device according to a modification of the third embodiment;

FIGS. 21A-21E are explanatory diagrams showing a mounting process of a ball according to the third embodiment; and

FIG. 22 is a graph showing a relation between a relative displacement of a second arm to a first arm and a load applied at the first and second arms in the mounting process according to the third embodiment.

### DETAILED DESCRIPTION OF THE PREFERRED EMBODIMENTS

### First Embodiment

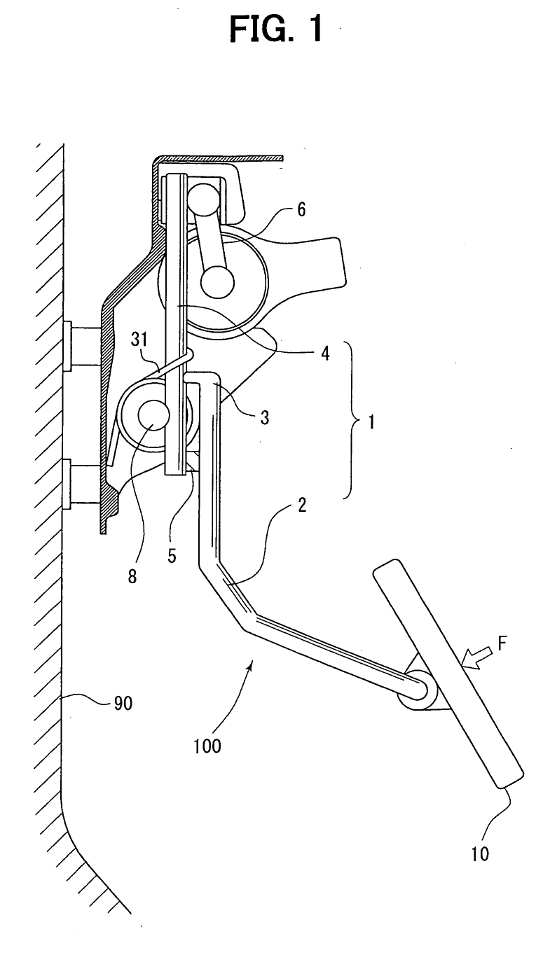

A pedal force detection device of the present invention according to the first embodiment will be described with reference to FIGS. 1-10.

The pedal force detection device includes a pedal arm unit 1 and a load sensor 5, and is arranged in a pedal assembly 100, which is fixed to a vehicle chassis 90, as shown in FIG. 1. The pedal arm unit 1 is provided with a first arm 2 at which a pedal 10 is mounted, a second arm 4 rotatably supported by a rotational support 8 and a connecting portion 3 which connects the first arm 2 to the second arm 4. The pedal 10 is depressed by a force which has a component force F perpendicular to the surface of the pedal 10. The load sensor 5 is inserted in a gap between the first arm 2 and the second arm 4 for determining the force F.

As shown in FIG. 1, a stroke sensor 6 is provided for the pedal assembly 100 at an upper portion of the second arm 4, and interlocked with the second arm 4 to detect a rotation displacement thereof. The stroke sensor 6 is constructed of a rotation sensor, for example. When the force F is exerted on the pedal 10 which is connected to the first arm 2, the pedal arm unit 1 including the second arm 4 rotates about the rotational support 8. The stroke sensor 6 detects the rotation displacement to generate a corresponding electric signal, which will be input to a control unit (not shown) such as a vehicle ECU. The control unit performs a predetermined program to calculate a displacement (depression amount) of the pedal 10 based on the electric signal.

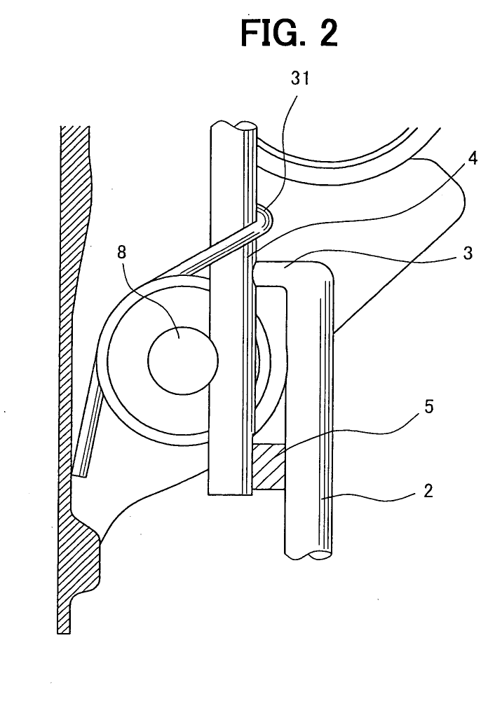

Referring to FIG. 2, a biasing unit such as a return spring 31 is attached to the rotational support 8 for providing a resistance to a rotation of the rotational support 8, so that the pedal arm unit 1 can be returned to the initial position (undepressed position) thereof when the force exerted on the pedal 10 is zero. In this embodiment, the connecting portion 3 is integrated with the first arm 2, and thus the pedal arm unit 1 can be readily assembled. The second arm 4 is fixed to the connecting portion 3, for example, by welding.

Moreover, when the force F is applied on the pedal 10, a rotation moment will be applied on the first arm 2. Then, the first arm 2 rotates about the boundary between the connecting portion 3 and the first arm 2, so that the first arm 2 has a rotation displacement (resilient deformation) toward the side of the second arm 4. Furthermore, the rotation moment will be applied on the connecting portion 3, so that the connecting portion 3 rotates about the boundary between the second arm 4 and the connecting portion 3 to have a rotation displacement (resilient deformation) in the direction of the rotation moment. As a result, the first arm 2 approaches the second arm 4 due to a total deformation of the first arm 2 and the connecting portion 3, to exert a load W on the load sensor 5. The load sensor 5 detects the load W to generate a corresponding electric signal, based on which the control unit performs a predetermined program to calculate the force F.

In this case, the second arm 4 is set to have a larger stiffness than the first arm 2 to have a smaller deformation. The load sensor 5 can be substantially supported by the second arm 4.

When the force F is increased so that the return spring 31 is deformable to resist the rotation of the second arm 4, a load corresponding to a difference between the force F and a resistance force of the return spring 31 is exerted on the load sensor 5 to be detected. On the other hand, when the force F is zero, the resistance force will return the first arm 2, the connecting portion 3 and the second arm 4 to the initial positions thereof.

In this embodiment, the load sensor 5 is provided with a load detection portion, in which multiple particles made of a material having a pressure-drag effect are distributed with electrical continuity in a matrix made of an electrical insulation material, for example, ceramics. When a load due to the force F is exerted on the load detection portion, the ohmic resistance thereof will be changed. Based on the variation of the ohmic resistance, the load can be detected to determine the force F which is applied on the pedal 10.

The ceramics matrix of the load detection portion can be composed of Zirconia (Zᵣo₂). Alternatively, Al₂O₃, MgAl₂O₄, SiO₂, 3Al₂O₃.2SiO₂, Y₂O₃, CeO₂, La₂O₃, Si₃N₄ or the like may be also used. In this embodiment, Zirconia (ZrO₂) is used, because it has a high pressure-withstanding strength against breakage. Thus, the load exerted on the load detection portion can be increased to improve the detection accuracy thereof, while the load detection portion is kept compact.

The particles having the pressure-drag effect can be made of at least one of (Ln₁₋ₓMaₓ)_{1-y}MbO_{3-z}, (Ln₂₋ᵤMa₁₊ᵤ)₁₋ᵥMb₂O_{7-F}, Si and a compound composed of minute quantities of additive element and one of (Ln₁₋ₓMaₓ)_{1-y}MbO_{3-z}, (Ln₂₋ᵤMa₁₊ᵤ)₁₋ᵥMb₂O_{7-F} and Si. Here, (Ln₁₋ₓMaₓ)_{1-y}MbO_{3-z} has a perovskite structure, in which 0<x≦0.5, 0≦y≦0.2, 0≦z≦0.6, Ln is a rare-earth element, Ma is composed of at least one kind of alkali-earth element and Mb is composed of at least one kind of transition metal element. (Ln₂₋ᵤMa₁₊ᵤ)₁₋ᵥMb₂O_{7-F} has a layer-like perovskite structure, in which 0<u≦1.0, 0≦v≦0.2, 0≦F≦1.0, Ln is a rare-earth element, Ma is composed of at least one kind of alkali-earth element and Mb is composed of at least one kind of transition metal element.

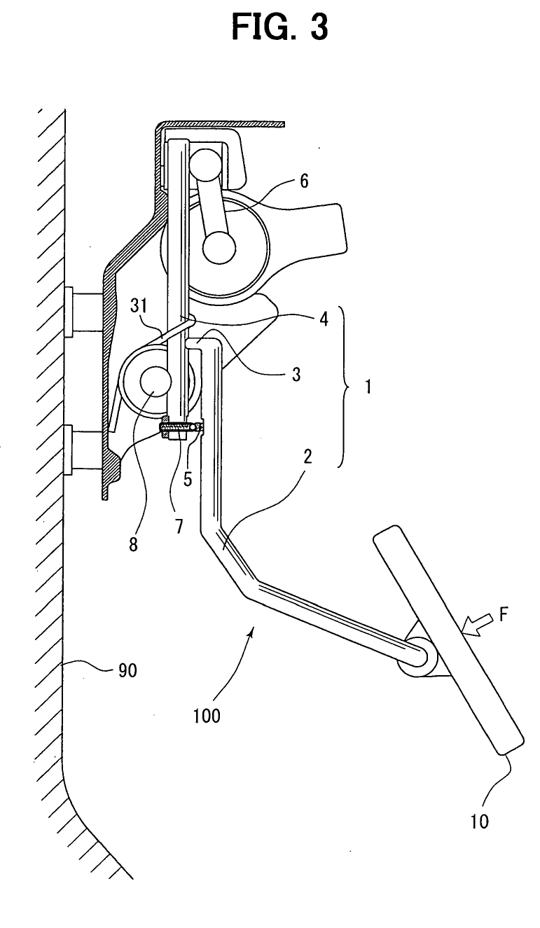

In the pedal force detection device shown in FIG. 3, a load adjusting unit 7 is attached to the load sensor 5 to reduce a detection error due to an initial installation load, which has been exerted on the load sensor 5 in manufacture. That is, the load adjusting unit 7 performs a zero-adjustment of the initial installation load.

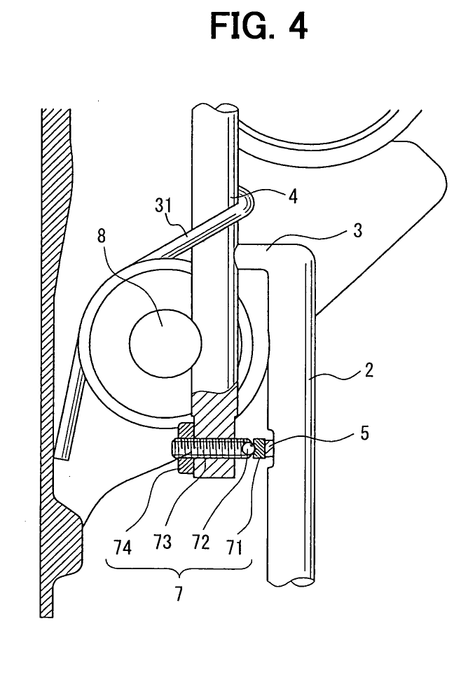

As shown in FIG. 4, the load adjusting unit 7 is provided with a base member 71, a nut 74, and a male screw 73 having a ball 72 at a tip thereof. The male screw 73 is screwed into a female screw formed in the second arm 4, while the ball 72 depresses the load sensor 5 on the first arm 2 through the base member 71 to fix the load sensor 5. The male screw 73 inserted into the female screw is fastened by the nut 74 at a predetermined position with respect to the second arm 4. A screwing amount of the male screw 73 with respect to the second arm 4 is adjusted to change the load applied on the load sensor 5, so as to provide the zero-adjustment for the initial installation load. In this case, the ball 72 is arranged at the tip of the male screw 73 for providing a spherical contact with the base member 71, so that the load from the male screw 73 can be effectively transmitted to the load sensor 5.

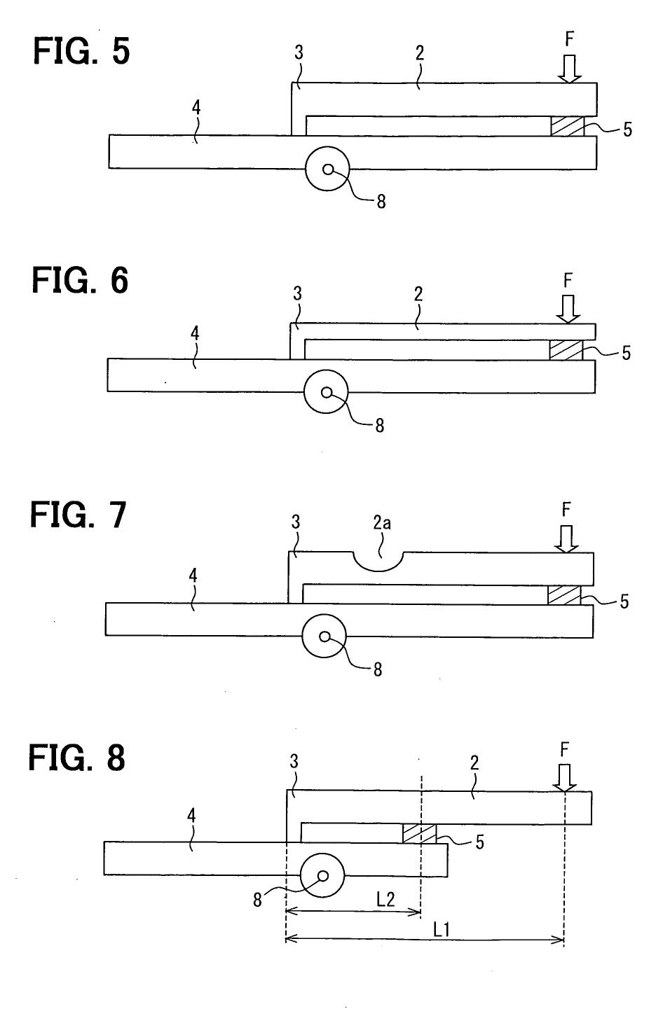

Various structures of the pedal force detection device according to the first embodiment will be described with reference to FIGS. 5-10, in which the position where the force F is exerted corresponds to the attachment position of the pedal 10 at the first arm 2.

In a structure of the pedal force detection device shown in FIG. 5, the first arm 2 is resilientally connected to the second arm 4 through the connecting portion 3. The load sensor 5 is interposed in the gap between the second arm 4 and the first arm 2 corresponding to the attachment position of the pedal 10. That is, the force F generates a zero rotation moment about the position where the load sensor 5 is disposed. In this structure, the first arm 2 is made of a material having a smaller stiffness than that of the second arm 4, so that the second arm 4 has a smaller resilient deformation than the first arm 2. Thus, the second arm 4 can substantially support the load sensor 5.

Because the first arm 2 is supported by the load sensor 5 and the second arm 4, the flexural strength of the first arm 2 can be set smaller than that of the second arm 4, which supports the load sensor 4 and the load sensor 5. Therefore, the first arm 2 can have a smaller size, that is, thinner than the second arm 4 in the direction of the force F, as shown in FIG. 6. Accordingly, in this structure, the second arm 4 has a larger stiffness than the first arm 2 to have a smaller resilient deformation, so that the load sensor 5 can be substantially supported by the second arm 4.

FIG. 7 shows a structure of the pedal force detection device, in which the first arm 2 has the same size (thickness) in the direction of the force F as the second arm 4 in total. A notch portion 2a is provided at the first arm 2, so that the first arm 2 has a smaller stiffness than the second arm 4. Thus, the second arm 4 has a smaller resilient deformation than the first arm 2 to substantially support the load sensor 5.

Referring to FIG. 8, L1 indicates the length of the first arm 2 from the connecting portion 3 to the attachment position of the pedal 10, where the force F is applied. L2 indicates the length of the second arm 4 from the connecting portion 3 to the position where the load sensor 5 is supported. In this structure, L1 is set larger than L2 to increase the load exerted on the load sensor 5, as compared with the above-described structures of the pedal force detection device (FIGS. 5 to 7). Thus, the corresponding electric signal generated by the load sensor 5 becomes larger to improve a signal-to-noise ratio. Therefore, the influence of noise on the detection of the force F can be reduced.

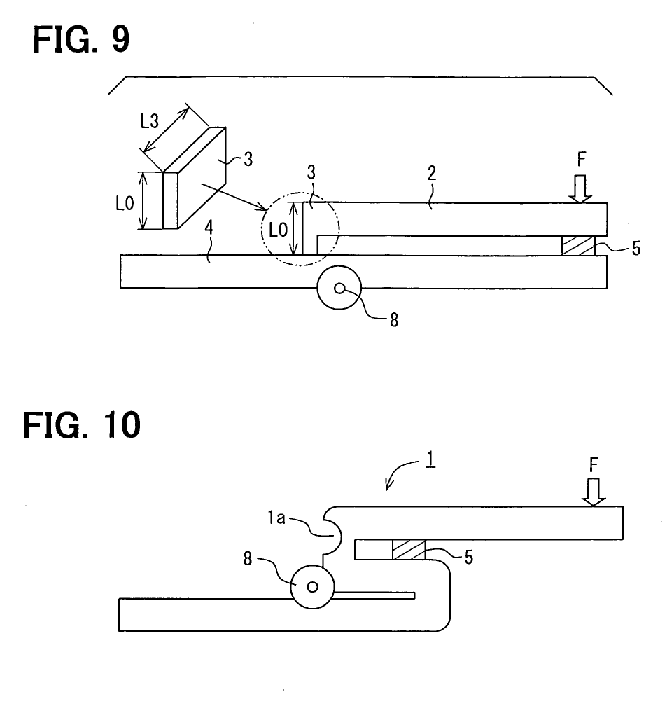

Referring to FIG. 9, the length L3 of the connecting portion 3 is a depth of the connecting portion 3 seen from the front face of the drawing sheet (FIG. 9), which is perpendicular to the direction of the force F. In this structure of the pedal force detection device, the length L3 is set larger than the length L0 in the force F direction of the connecting portion 3, so that the connecting portion 3 has a larger stiffness in the length L3 direction. Similarly, the first arm 2 and the second arm 4 are also set to have a larger size in the face-back direction (length L3 direction) of sheet in FIG. 9, respectively. Thus, a resilient deformation of the whole pedal arm unit 1 in the length L3 direction can be restricted, and then a load due to the resilient deformation exerted on the load sensor 5 can be restricted. Accordingly, the detection accuracy of the force F is improved. Moreover, a breakage of the pedal unit 1 in the length L3 direction can be diminished.

With reference to FIG. 10, all of the first arm 2, the second arm 4 and the connecting portion 3 are integrally formed, so as to simplify the assembly of the pedal force detection device and reduce the manufacture cost. In this structure, a notch 1a is provided at the part corresponding to the first arm 2 to have a smaller stiffness than the part corresponding to the second arm 4, so as to substantially support the load sensor 5. In addition, the second arm 4 can be also integrated with the connecting portion 3 while the first arm 2 is separately formed.

In this embodiment, the rotational support 8 is mounted at the middle portion of the pedal arm unit 1, where the first arm 2 is parallel to the second arm 4 and the load sensor 5 is inserted between the first arm 2 and one end of the second arm 4. The rotational support 8 can be also attached to the pedal arm unit 1 at the end portion thereof which is apart from the pedal 10, for example, at the other end of the second arm 4.

### Second Embodiment

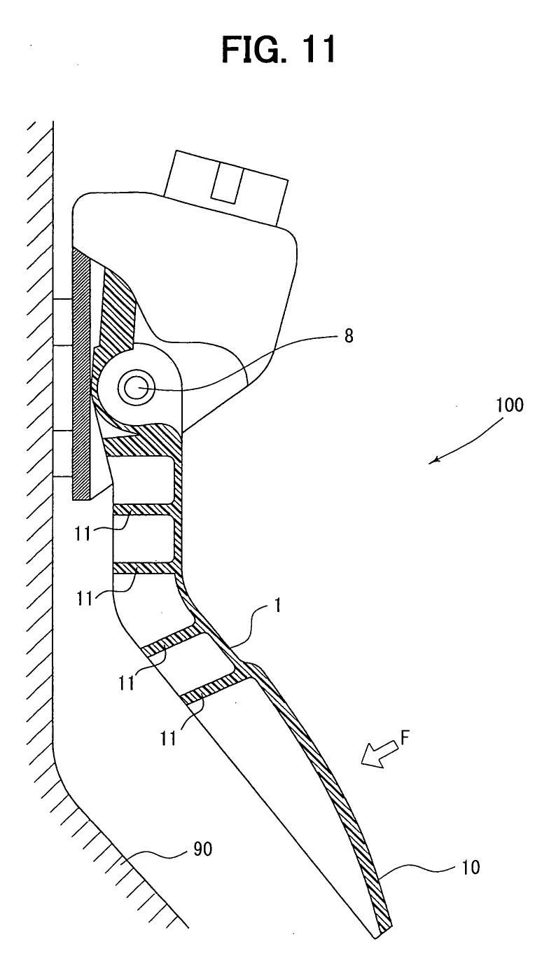

In the above-described first embodiment, the load sensor 5 is inserted between the first arm 2 and the second arm 4. In the second embodiment referring to FIGS. 11-15, the pedal force detection device is provided with a load detection unit 50 sandwiched in the pedal arm unit 1, which is made of a resin and integrally formed.

In a pedal assembly 100 shown in FIG. 11, the whole pedal arm unit 1 is integrally formed without the first arm 2 and the second arm 4. The pedal arm unit 1 has ribs 11, each of which extends in a direction perpendicular to a central axis of the pedal arm unit 1. The pedal 10 is also integrated with the pedal arm unit 1 at one end of the pedal arm unit 1. The other end of the pedal arm unit 1 is rotatablely supported by the rotational support 8. The biasing unit (not shown) such as the return spring is attached to the pedal arm unit 1 to provide a resistance against the rotation thereof. Thus, the pedal arm unit 1 can be maintained at the initial position when the force applied on the pedal 10 is zero.

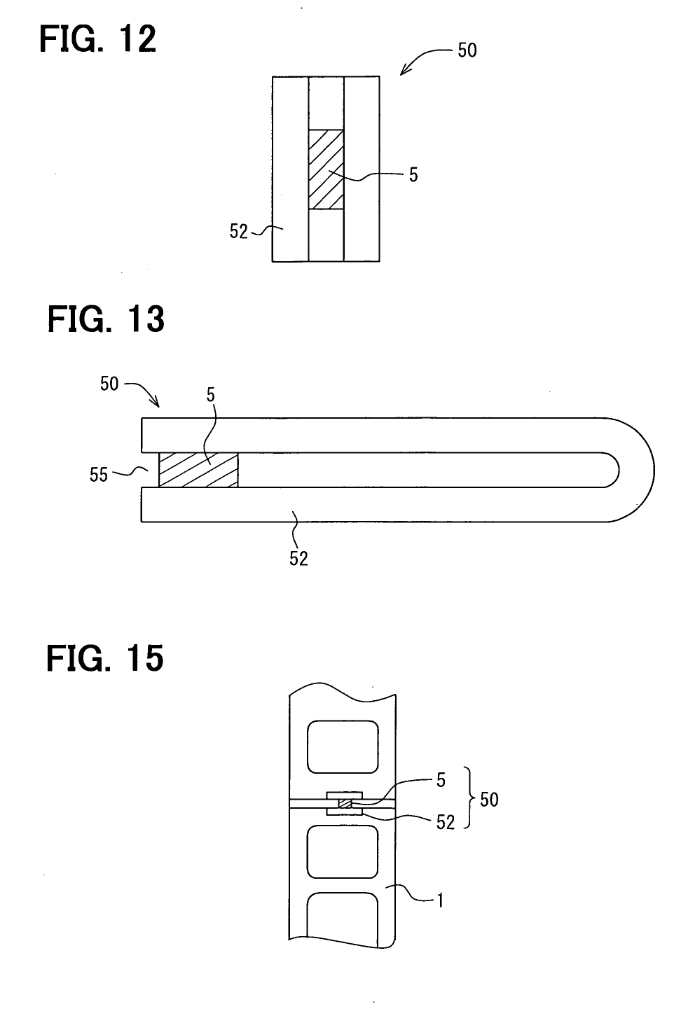

The load detection unit 50 shown in FIG. 12 is provided for detecting the force F applied on the pedal 10. Referring to FIG. 13, the load detection unit 50 includes a hold member 52 (i.e., U-shape member made of a metal) and a load sensor 5, which is fixedly inserted in an opening end 55 of the U-shape member 52. Furthermore, as shown in FIG. 12, the whole load sensor 5 is contained within the opening end 55.

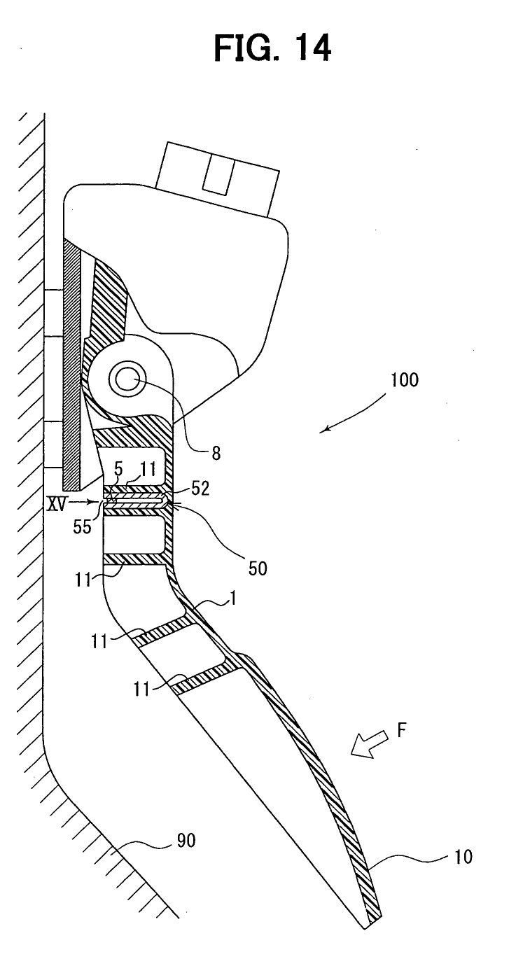

FIG. 14 shows the pedal assembly 100, in which the U-shape member 52 is sandwiched in one of the ribs 11. The U-shape member 52 is sandwiched (buried) in the pedal arm unit 1 at a position apart from the pedal 10, and the opening end 55 is disposed at an opposite side of the pedal 10. As shown in FIG. 15, the upper and lower surfaces of the U-shape member 52 are perpendicular to the central axis of the pedal arm unit 1. The upper part, the load sensor 5 and the lower part are sequentially arranged the up-to-down direction.

In this case, the load sensor 5 is inserted in the U-shape member 52 without a gap therebetween, and then the U-shape member 52 is buried in the pedal arm unit 1 to have a surface contact with the pedal arm unit 1. Therefore, the load applied on the resin pedal arm unit 1 by the U-shape member 52 can be decreased, and thus a creep of the resin is restricted. Accordingly, a gap between the pedal arm unit 1 and the U-shape member 52 can be restricted, so that the detection accuracy of the force F is improved.

As shown in FIG. 14, when the force F is exerted on the pedal 10, the pedal arm unit 1 will be rotated about the rotational support 8 by a rotation moment. Thus, an internal stress is generated in the pedal arm unit 1, which will have a resilient deformation (internal strain) in the direction of the rotation moment. As a result, the opening end of the U-shape member 52 is compressed. In this case, a continuing arch-shaped end (opposite to opening end) of the U-shape member 52 is stiffer than the opening end 55, so that the opening end 55 having a larger deformation compresses the load sensor 5 by a load. Based on the load detected by the load sensor 5, the force F can be determined.

### Third Embodiment

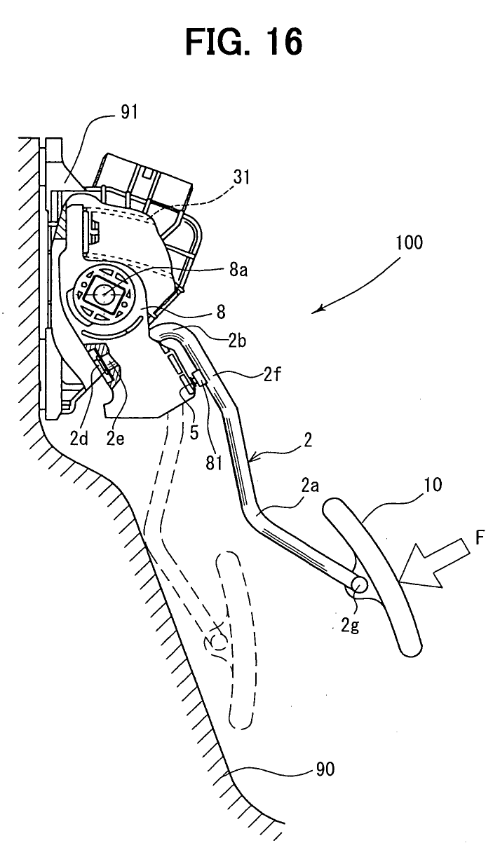

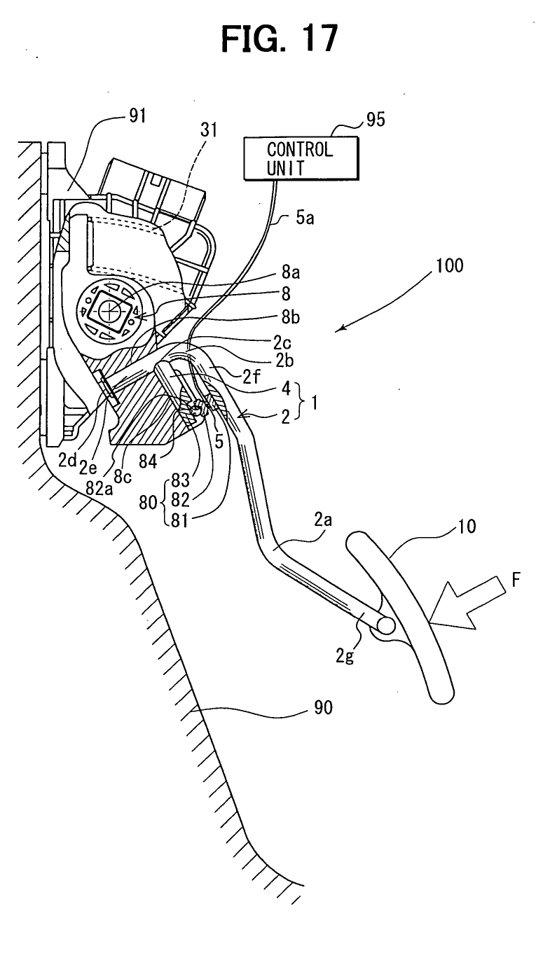

According to the above-described first embodiment, the rotational support 8 is attached to the second arm 4 to support the pedal arm unit 1. In the third embodiment as shown in FIGS. 16 and 17, both the first arm 2 and the second arm 4 are supported by the rotational support 8. Thus, the rotation of the pedal arm unit 1 will not be influenced even if the second arm 4 has a breakage. FIG. 16 shows the pedal assembly 100, in which the pedal force detection device including the pedal arm unit 1 and the load sensor 5 is mounted.

As shown in FIG. 17, the pedal arm unit 1 including the first arm 2 and the second arm 4 is mounted at the rotational support 8, which is rotatably supported by an attachment portion 91 fixed to the vehicle chassis 90. The first arm 2 is sequentially constructed with a pedal end portion 2g, a curve portion 2a, a parallel portion 2f, a bend portion 2b, a connection portion 2c and an insert end portion 2e. The pedal 10 is mounted at the pedal end 2g, so that pedal arm unit 1 is rotated when the force F is applied on the pedal 10. At the curve portion 2a, the pedal arm unit 1 is bent toward the side of the vehicle chassis 90. Thus, the pedal arm unit 1 will have a maximum rotation displacement when the curve portion 2a contacts the vehicle chassis 90 in a rotation, so that a breakage of the rotational support 8 due to an excessive rotation of the pedal arm unit 1 can be restricted. The bend angle of the curve portion 2a is set according to an admitted Maximum rotation displacement of the rotational support 8.

The parallel portion 2f is parallel and opposite to the linear second arm 4, one end of which is connected to the first arm 2 at the connection portion 2c. The connection portion 2c is arranged within the insert end portion 2e, which is adjacent to the parallel portion 2f. The bend portion 2b is a beginning of the insert end portion 2e, which is bent toward the side of the vehicle chassis 90 and inserted into a penetrating hole 8b provided in the rotational support 8. The tip of the insert end portion 2e protrudes from the penetrating hole 8b to be pressed and fixed by a fastening member 2d (e.g., washer), which is inserted between the rotational support 8 and the tip.

In this case, the second arm 4 is supported by a support surface 8c formed on the rotation support 8, so that the whole pedal arm unit 1 is restricted from rotating about the tip of the insert end portion 2e with reference to FIG. 17. Therefore, the load sensor 5 can be substantially supported by the second arm 4 to determine the pedal force F.

The rotational support 8 is rotatably supported by the attachment portion 91, so that the rotational support 8 can rotate about a rotation center 8a (rotation axis). The biasing unit 31 (e.g., return spring) is attached to the rotational support 8 to provide a resistance for the rotation of the pedal arm unit 1. Therefore, when the force exerted on the pedal 10 is zero, the pedal 10 can return to the initial position (undepressed position).

The load sensor 5 is made with the same material as described in the first embodiment. The load sensor 5 is connected to a control unit 95 (e.g., vehicle ECU) through a communication wire 5a. When the force F is exerted on the pedal 10, the load W is applied at the load sensor 5 to change the ohmic resistance thereof, then changing the current through the load sensor 5 which is provided with a predetermined voltage. Therefore, the electric signal input to the control unit 95 is changed, so that the pedal force F is detected.

FIG. 18 shows in more detail the load sensor 5 which is attached to the pedal arm unit 1. A first base member 81 is disposed between the load sensor 5 and the parallel portion 2f of the first arm 2, and contacts both of them by a plane contact. A second base member 82 and a ball 83 are sequentially arranged between the load sensor 5 and the second arm 4. The second base member 82 contacts the load sensor 5 by a plane contact. An approximate conical concavity 82a is formed at the second base member 82 on an opposite side of the load sensor 5 to contact the ball 83. As described above, the one end of the second arm 4 is connected to the connection portion 2c of the first arm 2. The other end of the second arm 4 is notched to have a plane portion, and a concavity 84 is formed at the plane portion to contact the ball 83. That is, the ball 83 is interposed between the concavity 84 and the conical concavity 82a.

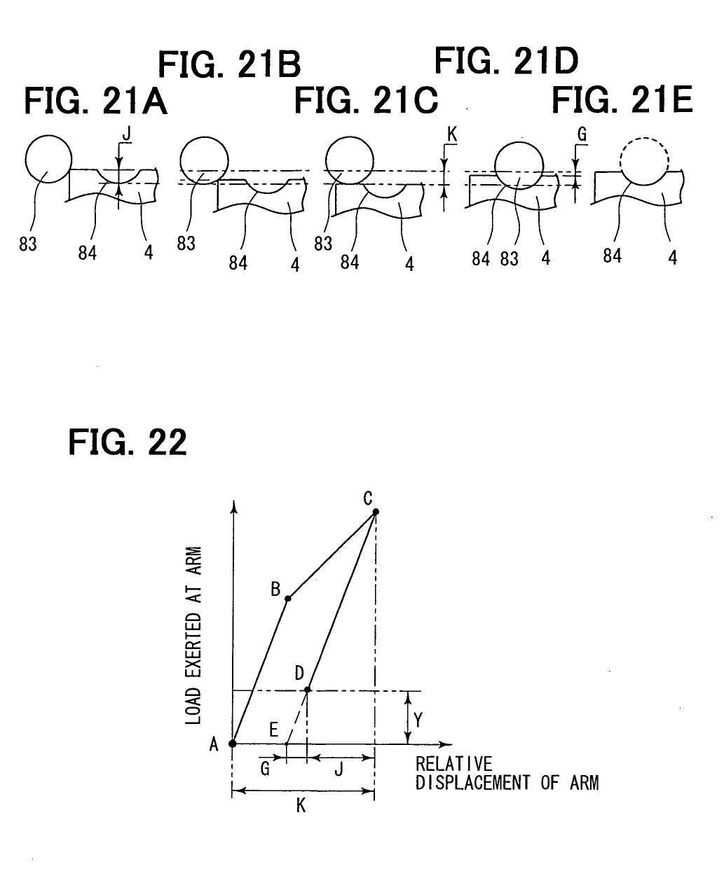

In an attachment of the load sensor 5 to the pedal arm unit 1, the first base member 81, the load sensor 5 and the second base member 82 are first assembled, for example, by adhering. Then, the assembly is fixed to the first arm 2 by adhering or the like. At last, the ball 83 is inserted between the concavity 84 and the conical concavity 82a. A mounting process of the ball 83 is shown in FIGS. 21A-21E.

The second arm 4 shown in FIGS. 21A-21E corresponds to a relative position thereof to the first arm 2. FIG. 22 shows a relation between a load applied at the first arm 2 (second arm 4) and a relative displacement of the second arm 4 to the first arm 2 in this mounting process. State points indicated as A-E in FIG. 22 correspond to the mounting states showing in FIGS. 21A-21E, respectively.

FIG. 21A shows the second arm 4 (pedal arm unit 1) which is not deformed when the ball 83 is not mounted. The second arm 4 begins to deform resiliently, accompanied by an inserting of the ball 83. FIG. 21B shows the second arm 4 which is deformed to an elastic limit. As shown in FIG. 21C, when the ball 83 is pressed to contact the plane portion of the other end of the second arm 4, the second arm 4 has a maximum deformation amount K. As shown in FIG. 21D, when the ball 83 falls in the concavity 84 from the plane portion, the second arm 4 keeps a remain deformation amount G with respect to the position thereof (shown in FIG. 21E) when the ball 83 is removed from the concavity 84, because the second arm 4 has been deformed over the elastic limit thereof in the inserting of the ball 83. Thus, a load Y corresponding to the remain deformation amount G will be exerted on the second arm 4 (ball 83), as shown in FIG. 22.

The depth J of the concavity 84 and the maximum deformation K of the second arm 4 can be set so that the remain deformation amount G is more than zero. Thus, an initial load (load Y) can be exerted on the ball 83 and transmitted to the first and second base members 81, 82. Each of the ball 83 and the first and second base members 81, 82 is made of a material capable of transmitting a load, so that an initial load is applied on the load sensor 5. Thus, the load sensor 5 can be fixed with respect to the pedal arm unit 1 without using other fastening members, and be restricted from leaving the attachment position even if the pedal 10 is raised.

In this case, the concavity 84 is formed at the plane portion of the second arm 4 to provide a surface contact between the second arm 4 and the ball 83. Accordingly, stress concentration in the ball 83 and the second arm 4 due to a point contact can be restricted, thus protecting the ball 83 and the second arm 4.

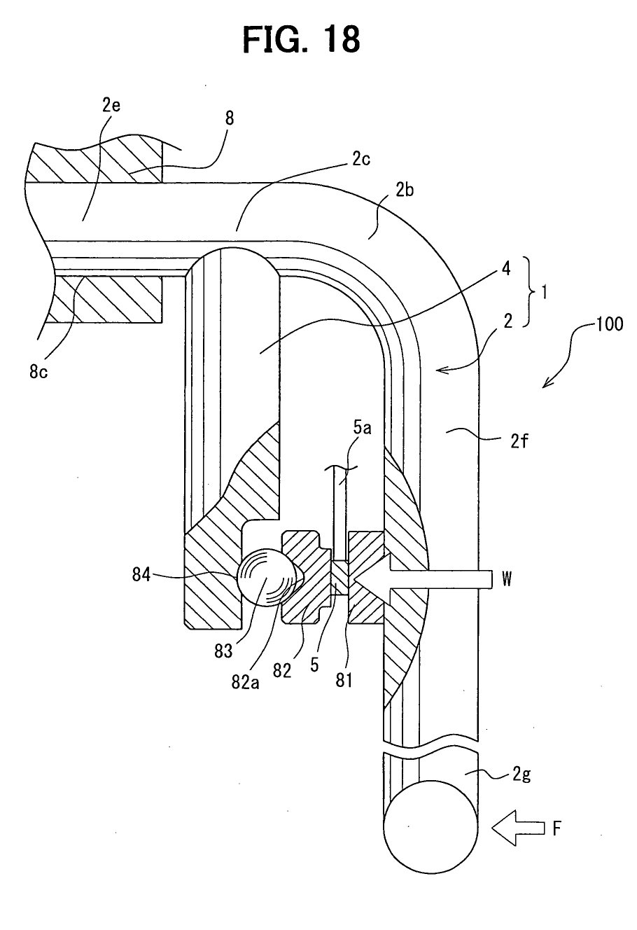

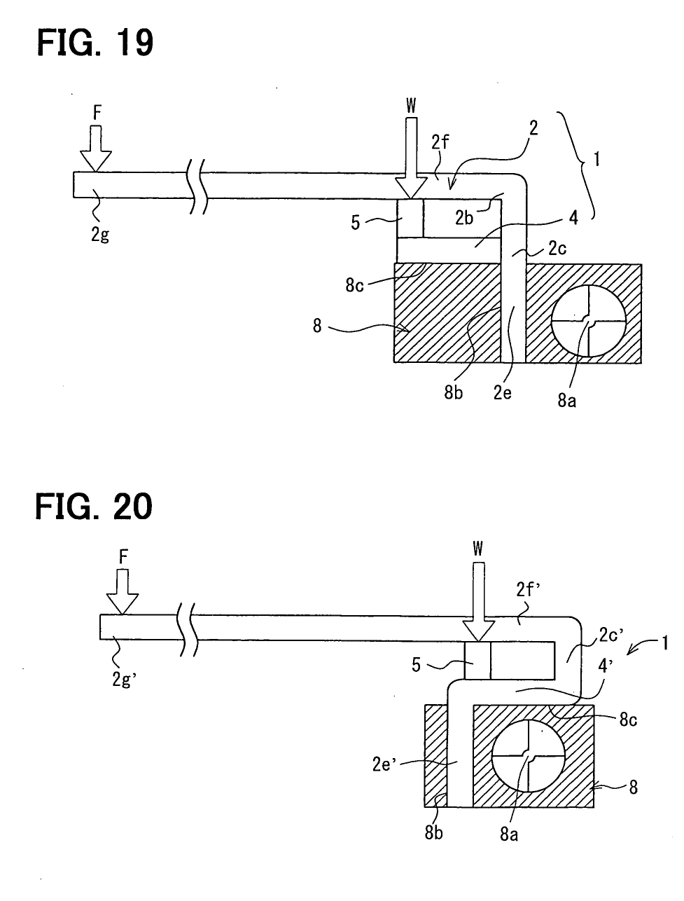

FIG. 19 is a schematic explanatory view of the structure of the pedal force detection device described above referring to FIGS. 16-18, where the pedal arm unit 1 is assembled by the first arm 2 and the second arm 4 which are separately formed. With reference to FIG. 20, the pedal arm unit 1 can be also integrally formed to simplify the assembling of the pedal force detection device.

As shown in FIG. 20, the pedal arm unit 1 is formed to sequentially include a pedal end portion 2g′, a curve portion 2a′ (not shown in FIGS. 19 and 20), a parallel portion 2f′, a connection portion 2c′, a contact portion 4′ and an insert end portion 2e′. The pedal force F is applied at the pedal 10 (not shown in FIG. 20) mounted at the pedal end portion 2g′. The curve portion 2a′ is formed same as the curve portion 2a described above. The parallel portion 2f′ is parallel and opposite to the contact portion 4′, and the connection portion 2c′ is disposed therebetween. The load sensor 5 is inserted between the parallel portion 2f′ and the contact portion 4′, which is supported by the support surface 8c of the rotational support 8. The insert end portion 2e′ is bent to be inserted in the penetrating hole 8b of the rotational support 8. Thus, the pedal arm unit 1 is fixed with respect to the rotational support 8.

In this case, the load sensor 5 is substantially supported by the contact portion 4′ which is mounted on the support surface 8c, so that the load sensor 5 can detect the load W exerted thereon to determine the pedal force F.

### Other Embodiment

Although the present invention has been fully described in connection with the first embodiment thereof with reference to the accompanying drawings, it is to be noted that various changes and modifications will become apparent to those skilled in the art.

The load detection unit of the load sensor 5 can be also covered by an insulation layer to be electrically insulated from outside devices. The insulation layer is made of Zirconia (ZrO₂), which is the same as that of the load detection unit to simplify the manufacture. Moreover, the insulation layer can be also made of Al₂O₃, MgAl₂O₄, SiO₂, 3Al₂O₃.2SiO₂, Y₂O₃, CeO₂, La₂O₃, Si₃N₄ or a ceramics material in which a material with the pressure-drag effect is distributed without an electrical continuity.

The load sensor 5 can be also provided with a matrix made of other material capable of withstanding the load due to the pedal force.

In the third embodiment, the load sensor 5 is disposed between the first and second base members 81, 82. However, the first base member 81 can be also omitted so that the load detection surface of the load sensor 5 contacts the first arm 2. Similarly, the second base member 82 can be also omitted. In this case, a part of the ball 83 is cut to form a plane portion for contacting the load sensor 5.

Moreover, in the third embodiment, the ball 83 is arranged between the second base member 82 and the second arm 4. However, the ball 83 can be also inserted between the first base member 81 and a concavity formed at the first arm 2, so that a remain deformation (relative displacement) is generated in the first arm 2 to exert the initial load on the load sensor 5. Furthermore, the ball 83 can also be a member, a part of which has a convex shape to contact the concavity formed at the first arm 2 or the second arm 4.

Such changes and modifications are to be understood as being within the scope of the present invention as defined by the appended claims.

1. A pedal force detection device for a vehicle having a pedal, comprising:
a pedal arm unit which is coupled with the pedal and resiliently deformable when the pedal is depressed by a force; and
a load sensor mounted at the pedal arm unit, the load sensor detecting a load applied thereon due to a resilient deformation of the pedal arm unit to determine the force.

2. The pedal force detection device according to claim 1, wherein:
the pedal arm unit includes:
a first arm at which the pedal is mounted;
a second arm disposed apart from the pedal; and
a connecting portion for connecting the first arm with the second arm; and
the load sensor is inserted between the second arm and the first arm, which is resiliently deformable to approach the second arm due to the force.

3. The pedal force detection device according to claim 2, wherein the load sensor has a matrix made of a ceramics.

4. The pedal force detection device according to claim 2, wherein the connecting portion is resiliently deformable when the pedal is depressed.

5. The pedal force detection device according to claim 4, wherein the connecting portion has larger stiffness in directions which are different from a direction of the resilient deformation due to the force.

6. The pedal force detection device according to claim 2, wherein the first and second arms have larger stiffness in directions which are different from a direction of the resilient deformation due to the force.

7. The pedal force detection device according to claim 2, wherein the pedal arm unit has a larger size in directions which are different from a direction of the resilient deformation due to the force.

8. The pedal force detection device according to claim 2, wherein:
the first arm has a part that is parallel to a part of the second arm; and
the connecting portion is perpendicular to both of the parts.

9. The pedal force detection device according to claim 2, wherein the first arm has smaller stiffness than the second arm.

10. The pedal force detection device according to claim 9, wherein the first arm is made of a material having smaller stiffness than that of the second arm.

11. The pedal force detection device according to claim 9, wherein the first arm is thinner in a direction of the force than that of the second arm.

12. The pedal force detection device according to claim 9, wherein the first arm has a part of smaller stiffness than the second arm only partially.

13. The pedal force detection device according to claim 2, wherein the load sensor is inserted between the first arm and the second arm at a position about which the force generates a zero rotation moment.

14. The pedal force detection device according to claim 2, wherein a length of the first arm from the connecting portion to a position at which the pedal is mounted is longer than a length of the second arm from the connecting portion to a position at which the load sensor is disposed.

15. The pedal force detection device according to claim 2, wherein the load sensor has an adjustment unit for adjusting an initial installation load of the load sensor.

16. The pedal force detection device according to claim 1, wherein:
the pedal arm unit includes:
a first arm at which the pedal is mounted; and
a second arm disposed apart from the pedal; and
the second arm has an end connected to the first arm which has a parallel portion opposite to the second arm, so that the load sensor is inserted between the second arm and the parallel portion.

17. The pedal force detection device according to claim 16, wherein the load sensor has a matrix made of a ceramics.

18. The pedal force detection device according to claim 16, wherein:
the first arm has an end portion which is apart from the pedal and adjacent to the parallel portion, the end portion being bent to a side of the second arm, and
the second arm is connected to the end portion near a position between the end portion and the parallel portion.

19. The pedal force detection device according to claim 16, further comprising
a biasing unit for maintaining the pedal arm unit at an initial position when the force applied on the pedal is zero.

20. The pedal force detection device according to claim 16, further comprising a rotational support unit for supporting both the first arm and the second arm.

21. The pedal force detection device according to claim 16, wherein the load is perpendicular to a contact surface between the first arm and the load sensor.

22. The pedal force detection device according to claim 16, further comprising:
a base member having a convex portion and disposed between the load sensor and at least one of the first and second arms which contact the base member at the convex portion, the base member being capable of transmitting the load.

23. The pedal force detection device according to claim 22, wherein at least the one of the first and second arms is provided with a concave portion to contact the convex portion.

24. The pedal force detection device according to claim 23, wherein the concave portion has a depth which is set so that an initial load is exerted on the load sensor.

25. A pedal force detection device for a vehicle having a pedal, comprising:
a pedal arm unit which is made of a resin and resiliently deformable when the pedal is depressed by a force; and
a detection unit, including:
a load sensor; and
a hold member in which the load sensor is inserted, the hold
member being sandwiched in the pedal arm unit,
wherein the load sensor detects a load exerted thereon due to a resilient deformation of the pedal arm unit to determine the force.

26. The pedal force detection device according to claim 25, wherein the load sensor has a matrix made of a ceramics.

27. The pedal force detection device according to claim 25, wherein the pedal is integrally formed with the pedal arm unit, center of gravity of which is between the pedal and the load sensor.

28. The pedal force detection device according to claim 25, wherein the hold member is made of a metal.

29. The pedal force detection device according to claim 27, wherein the hold member has an opening end in which the load sensor is inserted, the opening end being disposed at an opposite side of the pedal with respect to the pedal arm unit.

30. The pedal force detection device according to claim 1, wherein the load sensor is made of Zirconia and La₁₋ₓSrₓMnOₛ (0≦x≦1) which has a pressure-drag effect.
